(19) United States
(12) Patent Application Publication
(10) Pub. No.: US 2023/0056419 A1
(43) Pub. Date: Feb. 23, 2023

(54) TRIGGER FOR USE WITH VEHICLE TESTING

(71) Applicant: The Regents of the University of Michigan, Ann Arbor, MI (US)

(72) Inventors: Tyler S. WORMAN, Ypsilanti, MI (US); Gregory J. McGUIRE, Ann Arbor, MI (US); Edward R. SERZO, Ypsilanti, MI (US)

(21) Appl. No.: 17/889,565

(22) Filed: Aug. 17, 2022

Related U.S. Application Data
(60) Provisional application No. 63/233,954, filed on Aug. 17, 2021.

(51) Int. Cl. G01S 17/88; G01S 7/51; G01S 7/481; G01S 19/13; G01S 7/00

(52) U.S. Cl. CPC G01S 17/88; G01S 7/51; G01S 7/4813; G01S 19/13; G01S 7/003

(57) ABSTRACT

A lidar trigger device and method of operating a lidar trigger device that includes: a controller having a processor and memory, the memory storing computer instructions; a wireless communications device; a lidar unit having a light emitter and light detector; an electronic display; and a housing that surrounds the controller, the wireless communications device, the lidar unit, and the electronic display. When the computer instructions are executed by the processor, the lidar trigger device is configured to: cause light to be transmitted from the light emitter of the lidar unit; cause reflected light that is received at the light detector to be processed; determine whether the lidar unit was triggered based on processing of the reflected light; in response to determining that the lidar unit was triggered, generate a trigger reporting message; and send the trigger reporting message to a remote device via the wireless communications device.

### TECHNICAL FIELD

This disclosure relates to methods and systems for triggering events at a vehicle test facility.

### BACKGROUND

Vehicle testing may be carried out for various purposes, such as to test autonomous or semi-autonomous features of an automobile driving over a road and/or to measure performance of one or more aspects of the automobile. During the testing, information may be collected by onboard vehicle sensors and stored in memory for later analysis. The test facility may be configured with one or more roadside sensors that are along and/or proximate a road and that are configured to obtain and store sensor information. Conventional vehicle testing systems may be used to test the vehicle under one or more scenarios.

### SUMMARY

In accordance with an aspect of the disclosure, there is provided lidar trigger device that includes: a controller having a processor and memory, the memory storing computer instructions; a wireless communications device; a lidar unit having a light emitter and light detector; an electronic display; and a housing that surrounds the controller, the wireless communications device, the lidar unit, and the electronic display. When the computer instructions are executed by the processor, the lidar trigger device is configured to: cause light to be transmitted from the light emitter of the lidar unit; cause reflected light that is received at the light detector to be processed; determine whether the lidar unit was triggered based on processing of the reflected light; in response to determining that the lidar unit was triggered, generate a trigger reporting message; and send the trigger reporting message to a remote device via the wireless communications device.

According to various embodiments, this lidar trigger device may further include any one of the following features or any technically-feasible combination of some or all of these features:
the lidar trigger device includes a printed circuit board (PCB) to which the controller, the wireless communications device, the lidar unit, and the electronic display are connected;
the wireless communications device is or includes a cellular chipset;
the lidar trigger device includes a global navigation satellite system (GNSS) receiver, and wherein the GNSS receiver is surrounded by the housing;
the lidar unit is a single beam lidar device;
the lidar trigger device is configured to determine whether the lidar unit was triggered based on distance data, and wherein the distance data is obtained based on the processing of the reflected light;
the lidar trigger device is configured to determine that the lidar unit was triggered when the distance data indicates that an object is within a predetermined range of distances taken from the lidar trigger device;
the trigger reporting message indicates a trigger time;
the trigger reporting message indicates or includes distance data, and wherein the distance data is obtained based on the processing of the reflected light and indicates a distance at which an object was detected; and/or
the lidar trigger device is further configured so that sending the trigger reporting message includes publishing the trigger reporting message to a trigger data channel, and wherein the remote device is configured to access the trigger data channel so as to receive the trigger reporting message.

In accordance with another aspect of the disclosure, there is provided a method of reporting a trigger event at a test facility. The method is carried out by a lidar trigger device having: a controller that includes a processor and memory storing computer instructions; a wireless communications device; a lidar unit that includes a light emitter and light detector; an electronic display; and a housing that surrounds the controller, the wireless communications device, the lidar unit, and the electronic display. The method includes: causing light to be transmitted from the light emitter of the lidar unit; causing reflected light that is received at the light detector to be processed; determining whether the lidar unit was triggered based on processing of the reflected light; in response to determining that the lidar unit was triggered, generating a trigger reporting message; and sending the trigger reporting message to a remote device via the wireless communications device.

According to various embodiments, this method may further include any one of the following features or any technically-feasible combination of some or all of these features:
the lidar trigger device includes a printed circuit board (PCB) to which the controller, the wireless communications device, the lidar unit, and the electronic display are connected;
the wireless communications device is or includes a cellular chipset;
the lidar trigger device includes a global navigation satellite system (GNSS) receiver, and wherein the GNSS receiver is surrounded by the housing;
the lidar unit is a single beam lidar device;
the lidar trigger device is configured to determine whether the lidar unit was triggered based on distance data, and wherein the distance data is obtained based on the processing of the reflected light;
the lidar trigger device is configured to determine that the lidar unit was triggered when the distance data indicates that an object is within a predetermined range of distances taken from the lidar trigger device;
the trigger reporting message indicates a trigger time;
the trigger reporting message indicates or includes distance data, and wherein the distance data is obtained based on the processing of the reflected light and indicates a distance at which an object was detected; and/or
the step of sending the trigger reporting message includes publishing the trigger reporting message to a trigger data channel, and wherein the remote device is configured to access the trigger data channel so as to receive the trigger reporting message.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes a test facility triggering system, which has a lidar trigger device and a button trigger device, according to one embodiment;

FIG. 2 depicts a block diagram of components of the lidar trigger device of FIG. 1 according to one embodiment;

FIG. 3 depicts a block diagram of components of the button trigger device of FIG. 1 according to one embodiment; and

FIG. 4 is a flowchart of a method of reporting a trigger event at a test facility according to one embodiment.

### DETAILED DESCRIPTION

The system and method described herein enables certain actions to be carried out in response to detection of a trigger event that occurs at a vehicle test facility or as a part of vehicle testing. In one embodiment, a trigger device may generate and send a trigger reporting message to one or more remote devices and, in a particular embodiment, the trigger reporting message is published to a trigger data channel, which may be a data or communications channel that is used for broadcasting information pertaining to the occurrence of trigger events so that other devices may receive an indication of trigger event(s) that occurred by listening to the trigger data channel. In other embodiments, the trigger reporting message may specify a recipient, such as a test facility server that is used as a part of configuring and/or carrying out tests at the test facility.

In some embodiments, a lidar trigger device is provided that includes a microcontroller having a processor and memory storing computer instructions; a wireless communications device; a lidar unit having a light emitter and light detector; an electronic display; and a housing that surrounds the microcontroller, the wireless communications device, the lidar unit, and the electronic display. According to at least one embodiment, when the computer instructions are executed by the processor, the lidar trigger device is configured to: cause light to be transmitted from the light emitter of the lidar unit; cause reflected light that is received at the light detector to be processed; determine whether the lidar unit was triggered based on processing of the reflected light; in response to determining that the lidar unit was triggered, generate a trigger reporting message; and send the trigger reporting message to a remote device via the wireless communications device.

In another embodiment, a button trigger device is provided that includes a microcontroller having a processor and memory storing computer instructions; a wireless communications device; a pushbutton; and a housing that surrounds the microcontroller and the wireless communications device. According to at least one embodiment, when the computer instructions are executed by the processor, the button trigger device is configured to: detect operation of the pushbutton by a user; in response to detecting detect operation of the pushbutton by the user, generate a trigger reporting message; and send the trigger reporting message to a remote device via the wireless communications device.

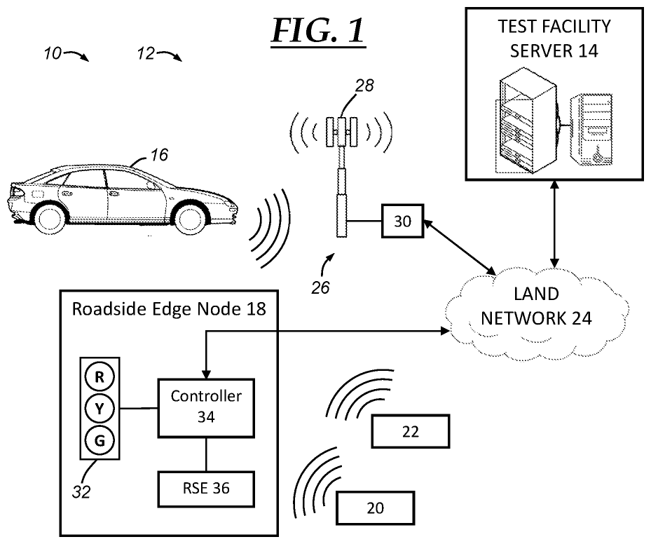

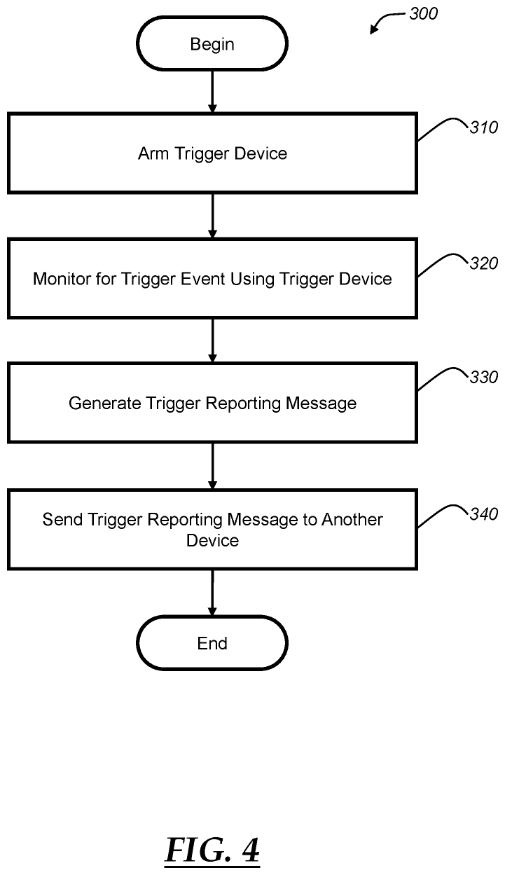

With reference now to FIG. 1, there is shown an operating environment that comprises a communications system 10 that is used at a test facility 12, a test facility server 14, a vehicle 16, a roadside edge node 18, a lidar trigger device 20, a button trigger device 22, a land network 24, and a wireless carrier system 26. The test facility 12 is an example of a vehicle testing environment at which the method (FIG. 4) may be carried out or used. In some embodiments, the vehicle testing environment may be located at a private testing facility and, in other embodiments, the vehicle testing environment may comprise one or more public facilities such as roads or other areas (e.g., a parking lot). It should be appreciated that while the illustrated embodiment of FIG. 1 provides an example of one such communications system 10, the system and method described below may be used as a part of various other communications system.

The land network 24 may be a conventional land-based telecommunications network that is connected to one or more landline telephones and connects the wireless carrier system 26 to the test facility server 14. For example, the land network 24 may include a public switched telephone network (PSTN) such as that used to provide hardwired telephony, packet-switched data communications, and the Internet infrastructure. One or more segments of the land network 24 could be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 26 may be any suitable cellular telephone system. The wireless carrier system 26 is shown as including a cellular tower 28; however, the wireless carrier system 26 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components used to connect the wireless carrier system 26 with the land network 24 or to connect the wireless carrier system 26 with user equipment (UEs, e.g., which may include telematics equipment in the vehicle 16 and a cellular chipset that is a part of the lidar trigger device 20 and/or the button trigger device 22), all of which is indicated generally at 30. The wireless carrier system 26 may implement any suitable communications technology, including for example GSM/GPRS technology, CDMA or CDMA2000 technology, LTE technology, etc. In general, the wireless carrier system 26, its components, the arrangement of its components, the interaction between the components, etc. is generally known in the art.

The test facility server 14 may be used to provide backend functionality to one or more components of the test facility 12. The test facility server 14 is a server that is carried out by one or more computers, each of which includes a processor and a non-transitory, computer-readable memory that is accessible by the processor. In one embodiment, the test facility server 14 may be in communication with the lidar trigger device 20 and/or the button trigger device 22. Additionally or alternatively, the test facility server 14 is used to store information concerning one or more components of the test facility 12 and/or to control one or more components of the test facility 12, such as a traffic signal 32 of the roadside edge node 18.

In one embodiment, the test facility server 14 is used to implement a software trigger. The software trigger may be invoked at a particular predetermined time, which may be preset or predetermined prior to carrying out vehicle testing at the test facility 12. In another embodiment, the software trigger may be invoked in response to a particular event that occurs at the test facility, such as detection of the traffic signal 32 changing from a RED signal to a GREEN signal. Upon invocation (i.e., triggering) of the software trigger, the test facility server 14 transmits a message on a trigger data channel, which may be a communications channel used for publishing and accessing trigger reporting messages. Each such message that reports the occurrence or triggering of a trigger is referred to herein as a “trigger reporting message”. The message may indicate a type of trigger (or “trigger type”) selected from a predetermined plurality of trigger types. In one embodiment, the predetermined plurality of trigger types includes SOFTWARE, LIDAR, and BUTTON—e.g., in an example where the trigger event is a result of a software trigger, the SOFTWARE trigger type may be selected. The message may further include data indicating a time at which the trigger event was detected or occurred and this time at which the trigger event was detected or occurred is referred to as the “trigger time.”

Any one or more of the processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers may include other memory, such as volatile RAM that is used by the processor, and/or may include multiple processors.

The vehicle 16 is depicted in the illustrated embodiment as a passenger car, but it should be appreciated that any other vehicle including motorcycles, trucks, sports utility vehicles (SUVs), recreational vehicles (RVs), bicycles, other vehicles or mobility devices including those that can be used on a roadway or sidewalk, etc., can also be used. The vehicle 16 includes vehicle electronics, which may include an onboard computer, a global navigation satellite system (GNSS) receiver, various sensors, a wireless communications device, and/or various other components.

The roadside edge node 18 is a collection of hardware or equipment that is located proximate a road, such as at an intersection or along the side of a highway. The roadside edge node 18 is illustrated in FIG. 1 as including a controller 34, roadside equipment 36, and the traffic signal 32. Although the roadside edge node 18 is shown as including certain components, according to various embodiments, other components may be used in addition to or in lieu of these components. For example, a traffic signal controller may be provided at the roadside edge node 18, and this traffic signal controller may be separate from the controller 34. This separate traffic signal controller may be used to control the traffic signal 32 and/or provide status information regarding the traffic signal 32, such as the state of the traffic signal 32 (e.g., a green light “G” of the traffic signal is illuminated or an amber (or yellow) light “Y” of the traffic signal 32 is blinking).

The controller 34 includes a processor and memory having computer instructions that are executable by the processor. The controller 34 is shown as being communicatively coupled to the land network 24 and data may be transferred between the controller 34 and one or more other components or devices of the communications system 10. In one embodiment, the controller 34 is communicatively coupled to the land network 24 via a cable modem; in another embodiment, the controller 34 is communicatively coupled to the land network 24 via the wireless carrier system 26 and, in such an embodiment, the controller 34 may include or be connected to a cellular chipset. In one embodiment, the controller 34 is used to implement a software trigger, which may be similar in nature to the software trigger described above that is implemented by the test facility server 14.

The roadside equipment (RSE) 36 includes hardware that is used to communicate with one or more vehicles that are at or at least proximate to the roadside edge node 18, such as the vehicle 16. The RSE 36 includes a SRWC circuit and, in some embodiments, may include a processor and memory that are separate than those of the controller 34. The SRWC circuit of the RSE 36 includes a chipset and/or other circuitry that enable use of one or more SRWC technologies, such as any of the IEEE 802.11 protocols (e.g., IEEE 802.11p, Wi-Fi™) WiMAX™, ZigBee™, Z-Wave™, Wi-Fi Direct™, Bluetooth™ (e.g., Bluetooth™ Low Energy (BLE)), or NFC. Although the RSE 36 is shown and described as being separate from the controller 34, in other embodiments, the RSE 36 and the controller 34 may be combined into a single device.

The RSE 36 may establish a wireless communications connection with one or more trigger devices, such as the lidar trigger device 20 and the button trigger device 22. In one embodiment, a Wi-Fi™ connection is established between the RSE 36 and each of the lidar trigger device 20 and the button trigger device 22. In such an embodiment, the RSE 36 may operate as a hotspot or wireless access point and each of the lidar trigger device 20 and the button trigger device 22 may operate as a client device. In one embodiment, the lidar trigger device 20 and the button trigger device 22 may be preconfigured with connection information that is usable to establish and/or secure a connection with the RSE 36 (or another wireless access point). For example, a service set identifier (SSID) and password for the wireless access point hosted by the RSE 36 may be prestored in each of the lidar trigger device 20 and the button trigger device 22. Pre-storing this connection information may be carried out as a part of an initial configuration process that may be carried out prior to any testing.

The traffic signal 32 is depicted as a stoplight or traffic light (“R” for a RED signal, “Y” for YELLOW or AMBER signal, and “G” for GREEN signal), but it should be appreciated that other traffic signaling devices can be used instead, such as any electronic signaling device that may be used to indicate information to a vehicular or pedestrian user of the roadway. Additionally, although there is only one traffic signal shown, it should be appreciated that numerous traffic signals may be used as a part of the system 10 and/or as a part of the roadside edge node 18, and that various different types of traffic signaling devices may be used. The traffic signal 32 may be connected to the controller 34, and the controller 34 may include suitable hardware components or interfaces so that it may connect to the traffic signal 32, such as for purposing of receiving status information (e.g., data indicating a present state of the traffic signal, such as whether the traffic signal is presently RED or GREEN) and/or controlling the traffic signal 32.

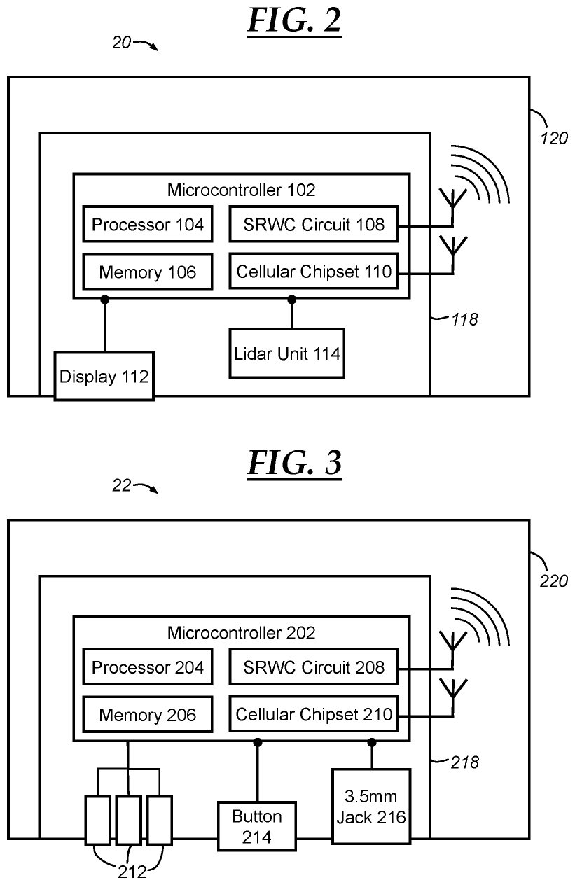

The lidar trigger device 20 and the button trigger device 22 are each a trigger device. As used herein, a trigger device includes a wireless communications device, a sensor, and a controller. With reference to FIGS. 2-3, there is shown a block diagram depicting hardware of the lidar trigger device 20 (FIG. 2) and the button trigger device 22 (FIG. 3). Although the illustrated embodiment depicts each of the trigger devices 20,22 having particular components, it should be appreciated that, according to other embodiments, the trigger devices 20,22 may have different components in lieu of or in addition to those depicted in FIGS. 2-3. Each of the lidar trigger device 20 and the button trigger device 22 may be powered using one or more disposable batteries, rechargeable batteries, and/or a hardwired power supply, such as one that connects to an electrical grid or power system. In one embodiment, either or both of the lidar trigger device 20 and the button trigger device 22 includes a global navigation satellite system (GNSS) receiver that is used for determining a geographical location of the trigger device 20,22. When the trigger device includes a GNSS receiver, the trigger device may include the geographical location, which may be taken at or around the time that the triggering event is detected, in the trigger reporting message so that the trigger reporting message indicates the geographical location at which the trigger event was detected and/or occurred. In other embodiments, either or both the lidar trigger device 20 and the button trigger device 22 do not include a GNSS receiver.

The lidar trigger device 20 and the button trigger device 22 each include a controller 102,202 that is disposed on a printed circuit board (PCB) 118,218. The controller 102,202 is illustrated as a microcontroller and includes a processor 104,204 and memory 106,206. It should be appreciated that various types of controllers, processors, and memory may be used. The controller 102,202 includes a short-range wireless communication (SRWC) circuit 108,208 and a cellular chipset 110,210. The SRWC circuit 108,208 includes an antenna and is used to transmitting and receiving wireless signals according to one or more SRWC technologies, such as any one or more of the IEEE 802.11 protocols (e.g., IEEE 802.11p, Wi-Fi™), WiMAX™, ZigBee™, Z-Wave™, Wi-Fi Direct™, Bluetooth™ (e.g., Bluetooth™ Low Energy (BLE)), and/or near field communication (NFC). The cellular chipset 110,210 includes an antenna and is used for carrying out cellular communications or long-range radio communications with the wireless carrier system 26. Although each of the lidar trigger device 20 and the button trigger device 22 include both a SRWC circuit and cellular chipset, in other embodiments, the lidar trigger device 20 and/or the button trigger device 22 may include a SRWC circuit but not a cellular chipset and, in yet another embodiment, the lidar trigger device 20 and/or the button trigger device 22 may include a cellular chipset but not a SRWC circuit.

The lidar trigger device 20 includes an electronic display (or simply “display”) 112 and a lidar unit 114. The button trigger device 22 includes a plurality of light emitting diodes (LEDs) 212, a button 214, and a 3.5 mm jack 216. The lidar trigger device 20 and the button trigger device 22 each include a housing 120,220 that houses the PCB 118,218 and the components attached thereto. The housing 120,220 may be comprised of a variety of suitable materials, including different kinds of plastic, rubber, other polymers, metal, etc. In one embodiment, the housing material may be selected so that it is transmissive to electromagnetic radiation, which may include light emitted by the lidar unit 114 and/or wireless signals transmitted to or by the SRWC circuit 108,208 and/or the cellular chipset 110,210.

With reference specifically to FIG. 2, the electronic display 112 of the lidar trigger device 20 is used to present information to a user of the lidar trigger device 20. The electronic display 112 is a touchscreen display that enables a user to provide input into the lidar trigger device 20. In this sense, the electronic touchscreen display 112 is a human-machine interface (HMI) capable of functioning as an HMI input device that receives input from a user and an HMI output device that presents information to a user. The input device of the electronic display 112 may be comprised of any suitable sensing technology, such as a resistive touchscreen sensor, a capacitive touchscreen sensor, or a surface acoustic wave (SAW) touchscreen sensor, to name a few. The output device of the electronic display 112 may be any suitable electronic display, such as a liquid crystal display (LCD), a light emitting diode (LED) display, or a plasma display, to name a few. In other embodiments, the electronic display 112 is not a touchscreen and does not include or function as an HMI input device that is capable of receiving input from a user. In such embodiments, the lidar trigger device may be provided with one or more separate HMI input devices, such as pushbuttons, electronic switches, or microphones, to name a few. The electronic display 112 may be mounted or fixed to the PCB 118 and surrounded by the housing 120. The housing 120 includes a screen space that is sized according to the screen of the electronic display 112 so that the touchscreen is usable by a user—i.e., the screen is viewable by the user and touch input from a user is capable of being received at the electronic display 112. The screen space may include a transmissive cover that hermetically seals the electronic display 112 within the housing 120 while also being usable for receiving touch input from a user.

The lidar unit 114 of the lidar trigger device 20 includes a light emitter and a light detector. The lidar unit 114 is used to obtain range or distance data (referred to herein as “distance data”) of one or more objects within the environment. The distance data obtained by the lidar unit 114 may be sent to the controller 102, where it may be processed by the processor 104 and/or stored in the memory 106. The lidar unit 114 is a single beam lidar device that projects a single beam using the light emitter and, after reflecting off of an object in the environment, is detected or received at the light detector of the lidar unit 114. The lidar unit 114 does not include a scanner and only transmits a single beam of light in one direction. Although the lidar unit 114 is described as being a single beam lidar device, it should be appreciated that, in other embodiments, the lidar unit 114 may be another type of lidar device, such as those having scanning capabilities and/or using more than one light beam. The light transmitted by the lidar unit 114 may be electromagnetic radiation having a wavelength within the range of 250 nanometers (ultraviolet) to 10 micrometers (infrared). An example of a lidar unit that may be used as the lidar unit 114 is the LIDAR-Lite v3 manufactured by Garmin™ The housing 120 of the lidar trigger device 20 may be transmissive to the light emitted by the lidar unit 114 and/or the housing 120 may include a lidar space or portion that is transmissive to the light emitted by the lidar unit 114. The lidar unit 114 may be used for monitoring for a trigger event. The trigger event may be an event in which an object is detected as being a certain distance from the lidar unit 114 or the lidar trigger device 20. Upon the lidar trigger device 20 detecting a trigger event, the lidar trigger device 20 initiates a triggering process that reports the trigger event to another device, such as to the test facility server 14. As used herein, a trigger device (e.g., the lidar trigger device 20, the button trigger device 22) is said to be “armed” when it is currently monitoring for a trigger event that, when detected, causes the trigger device to initiate a triggering process in which the trigger event is reported to another device.

With reference to FIG. 3, the plurality of LEDs 212 of the button trigger device 22 are used to communicate information about the button trigger device 22 to the user, such as a status of the button trigger device 22. For example, one or more of the LEDs 212 may be used to indicate that the button trigger device 22 is armed. While three LEDs 212 are illustrated in FIG. 3, it should be appreciated that any number of LEDs may be used according to other embodiments. For example, in another embodiment, the button trigger device 22 may include only a single LED or may not include any LEDs. The housing 220 of the button trigger device 22 may include a space and/or transmissive portion for the LEDs 212 so that light emitted by the LEDs 212 is visible to a user. The pushbutton (or simply “button”) 214 of the button trigger device 22 is a pushbutton that operates as a switch so that the button trigger device 22 is able to detect when the pushbutton 214 has been pressed or otherwise operated by a user. In some embodiments, the button 214 may be an electromechanical push button switch, for example. The pushbutton 214 may be used to receive input from the user and, when the button trigger device 22 is armed, the pushbutton 214 acts to detect the triggering of an even. When triggered (i.e., when the pushbutton 214 is pressed), the button trigger device 22 initiates a triggering process that reports the trigger event to another device, such as to the test facility server 14. In other embodiments, the button trigger device 22 may include a plurality of pushbuttons, such as one or more pushbuttons used for configuring or arming the button trigger device 22 and another, separate pushbutton for detecting a trigger event. The housing 220 of the button trigger device 22 may include a space for the pushbutton 214 so that the pushbutton 214 is operable by a user.

The 3.5 mm jack 216, which is an example of an auxiliary port, of the button trigger device 22 is used to provide a data connection between the button trigger device 22 and another device. In some embodiments, the device connected to the 3.5 mm jack 216 may act as a trigger device for detecting a trigger event. For example, a microphone may be connected to the 3.5 mm jack 216 and, when sound over a certain threshold is received by the microphone, a triggering process is initiated by the button trigger device 22. In another embodiment, other sensors may be connected to the 3.5 mm jack 216 and used to monitor for a trigger event. Examples of other sensors that may be used include an image sensor, a radar sensor, an inertial sensor, a temperature sensor, an infrared sensor, a movement sensor, a pressure sensor, etc. The types of sensors or input devices may be selected based on the type of trigger event that is being monitored and, according to some embodiments, the trigger event(s) being monitored may include relate to the actions or presence of vehicles, pedestrians, non-human animals, robots or robotic devices, etc. In general, the 3.5 mm jack 216 may be connected to any suitable circuitry that includes a switch operable by a user or responsive to a sensor. In other embodiments, other types of auxiliary ports or input ports/connections may be used in addition to or in lieu of the 3.5 mm jack 216 so as to receive input at the trigger device. In some embodiments, a trigger device may include those components of the button trigger device 22, but without the pushbutton 214 or without using the pushbutton 214 for detecting a trigger event, but with one or more sensors or input devices for detecting trigger event(s), such as any one or more of those examples of sensors recited above.

While the lidar trigger device 20 and the button trigger device 22 are each described and illustrated herein as having particular components, it should be appreciated that, according to other embodiments, these devices 20,22 may include other components in addition to or in lieu of those components specifically discussed and described herein. For example, the lidar trigger device 20 may include one or more pushbuttons and/or a 3.5 mm jack, and the button trigger device 22 may include an electronic display instead of the plurality of LEDs 212.

With reference to FIG. 4, there is shown an embodiment of a method 300 of reporting a trigger event at a test facility. According to at least some embodiments, the method 300 is used to detect and report a trigger event that was detected, such as by a trigger device (e.g., the lidar trigger device 20, the button trigger device 22), and that occurred within a test facility, such as the test facility 12 in which experiments or tests are carried out on and/or using one or more vehicles. In one embodiment, the trigger events may be detected and recorded so as to track and record certain events that occur at the test facility 12. For example, when the vehicle 16 enters the field of view of the lidar unit 114 (and, assuming that the lidar trigger device 20 is armed), a trigger event may be detected and then recorded. Additionally or alternatively, in response to detecting a trigger event, a state of the test facility may be changed—for example, a traffic signal may change from a RED signal to a GREEN signal upon a trigger event occurring, which may be, for example, a user pressing the pushbutton 214 of the button trigger device 22. Of course, various other use cases may be implemented using the system, devices, and methods described herein.

The method 300 begins with step 310, wherein a trigger device is armed. The trigger device may be locally armed or may be remotely armed. As used herein, locally arming a trigger device means using one or more human-machine interfaces (HMIs) that are provided as a part of the trigger device or that are physically connected to the trigger device. For example, the electronic touchscreen display 112 may be used by a user to arm the lidar trigger device 20, such as through the user navigating a graphical user interface (GUI) having an “arm device” option that is selectable by the user. As another example, the pushbutton 214 of the button trigger device 22 may be actuated by a user according to a predetermined sequence to arm the button trigger device 22. The LEDs 212 may indicate a status of the button trigger device 22, such as emitting a RED light from one of the LEDs 212 to indicate the button trigger device 22 is armed. Of course, in other embodiments, various other HMIs may be used to arm the trigger device.

As used herein, remotely arming a trigger device means causing the trigger device to become armed without using any HMIs provided as a part of the trigger device or that are physically connected to the trigger device, such as by way of the 3.5 mm jack 216. For example, the test facility server 14 may generate and send a remote arming message to the lidar trigger device 20 that causes the lidar trigger device 20 to become armed. In one embodiment, the remote arming message may cause the trigger device to become armed upon receipt of the remote arming message or may specify a time at which to arm the trigger device (e.g., a particular time of day, a delay from when the remote arming message is received).

In some embodiments, a user may specify certain arming parameters and/or trigger parameters. An arming parameter is a parameter that relates to the arming of the trigger device and some examples include a start time at which to arm the device and an end time at which to disarm the device. A trigger parameter is a parameter that relates to the triggering of the trigger device, such as a range of distances (as measured by the lidar unit 114 of the lidar trigger device 20) that will cause a trigger process to begin or a sequence of button presses of the pushbutton 214 of the button trigger device 22.

In some embodiments, a test configuration that specifies certain parameters used for testing at the test facility 12 may specify one or more arming and/or trigger parameters for one or more of the trigger devices. The test configuration may be specified by a user through use of an application programming interface (API) that is used in conjunction with the test facility 12, such as an API endpoint that is hosted and/or associated with the test facility server 14. For example, a user may operate a graphical user interface (GUI) using a client device, such as a handheld mobile device (e.g., a smartphone, tablet) or a personal computer (PC), to specify one or more arming and/or trigger parameters for one or more of the trigger devices. The GUI may then send one or more messages to an API endpoint, which may be hosted by the test facility server 14. The API endpoint may then cause the one or more trigger devices to be configured according to the one or more arming and/or trigger parameters specified by the user.

In embodiments where a software trigger is used, instead of arming a trigger device, such as the lidar trigger device 20 or the button trigger device 22, a computer may be configured to invoke a software trigger. For example, the test facility server 14 may be configured to invoke a trigger event at a particular, predetermined time or in response to receiving a message from another device. In some embodiments, the software trigger may also be configured by a user through use of the API described above. The method 300 continues to step 320.

In step 320, the trigger device monitors for a trigger event. In one embodiment, when the lidar trigger device 20 is armed, the lidar trigger device 20 obtains distance data using the lidar unit 114. In particular, the lidar unit 114 transmits light using its light emitter and then receives reflected light using its light detector, which may then be processed to determine whether the lidar trigger device was triggered. In one embodiment, the detection of any object, regardless of the object's distance, by the lidar unit 114 may result in determining that the lidar unit was triggered. However, in at least some embodiments, the lidar trigger device 20 may be configured to determine that a trigger event has occurred when an object is detected within a particular range, such as between 10-15 m. Using lidar processing techniques known in the art, the lidar unit 114 may, through processing the reflected light that is received at the light detector, produce distance data indicating a range/distance (e.g., 20 meters) at which an object is detected. In such an example, after receiving distance data from the lidar unit 114, the lidar trigger device 20 determines whether the distance indicated by the distance data is within the range of distances indicated by the trigger parameters. If so, a trigger event has occurred and the method 300 continues to step 330; otherwise, the lidar trigger device 20 continues monitoring for a trigger event.

In the case of the button trigger device 22, a trigger event may be detected when the pushbutton 214 is pressed (assuming the button trigger device 22 is armed). In another embodiment, a device, such as a microphone, may be connected to the button trigger device 22 via the 3.5 mm jack 216. In such a case, a trigger event may be detected when audio above a certain decibel level is detected while the button trigger device 22 is armed. If a trigger event is detected, the method 300 continues to step 330.

In step 330, in response to detecting a trigger event, a trigger reporting message is generated by the trigger device. The trigger reporting message is a message that indicates that a trigger event was detected by a particular trigger device. In one embodiment, the trigger reporting message includes a unique identifier that uniquely identifies the trigger device from other trigger devices being used at the test facility. The unique identifier may be hardcoded into the trigger device. In at least some embodiments, the trigger reporting message indicates a trigger time and a trigger type, which may be “LIDAR” in the case of the lidar trigger device 20, “BUTTON” in the case of the button trigger device 22, or “SOFTWARE” in the case of a software trigger.

In at least one embodiment, the trigger reporting message includes information about the trigger event, such as a distance at which an object was detected by the lidar unit 114 in the case of the lidar trigger device 20 or information indicating whether the pushbutton 214 was pressed or whether a device connected via the 3.5 mm jack 216 detected a trigger event. As mentioned above, a sensor, such as a microphone, may be coupled to the button trigger device 22 via the 3.5 mm jack 216 and used to detect a trigger event, such as when a detected decibel level is above a threshold amount. In such a case, a detected decibel level may be included as a part of the trigger reporting message. Other information can be included in the trigger reporting message, such as trigger parameters and/or arming parameters. The trigger reporting message (and/or certain data contained in the trigger reporting message (e.g., the trigger time, one or more trigger parameters, distance data, other sensor data)) may be stored on the memory of the trigger device, such as the memory 106 of the lidar trigger device 20 or the memory 206 of the button trigger device 22. The method 300 continues to step 340.

In step 340, the trigger reporting message is sent to a remote device. In one embodiment, the trigger reporting message is sent from the trigger device to the test facility server 14. For example, in the case of the lidar trigger device 20, the trigger reporting message may be sent to the test facility server 14 via a Wi-Fi™ connection between the SRWC circuit 108 of the lidar trigger device 20 and the SRWC circuit of the RSE 36; then, the trigger reporting message may be sent from the RSE 36 to the test facility server 14 via controller 34 and land network 24. As another example, in the case of the button trigger device 22, the trigger reporting message is sent to the wireless carrier system 26 via a cellular connection between the cellular chipset 210 of the button trigger device 22 and the cell tower 28, and then the trigger reporting message is sent from the wireless carrier system 26 to the test facility server 14 via the land network 24. The remote device, which may be the test facility server 14, may store the trigger reporting message in memory and/or may send the trigger reporting message, certain data contained in the trigger reporting message, or certain data concerning the trigger reporting message to another device, such as to the controller 34 of the roadside edge node 18. The method 300 then ends.

In some embodiments, a remote device may be configured to carry out an action in response to receiving a trigger reporting message. For example, in response to receiving a trigger reporting message from the lidar trigger device 20 at the controller 34, the controller 34 may cause the traffic signal 32 to change from emitting a RED light to emitting a GREEN light. This may be useful when, for example, the vehicle 16 approaches the traffic signal 32 and the presence of the vehicle 16 may be detected by the lidar unit 114 of the lidar trigger device 20.

In another embodiment, data may be collected and/or stored in response to the occurrence of a trigger event. For example, when a trigger event occurs (e.g., an object is detected as being in the field of view of the lidar unit 114 of the lidar trigger device 20), the system may cause a sensor at the roadside edge node 18 to obtain sensor data (e.g., image data using a camera) and the sensor data may then be stored. In such an example, the controller 34 may obtain the trigger reporting message from the lidar trigger device 20 (and/or trigger data channel) and, in response, may cause one or more sensors to record sensor data. The sensor data may then be stored locally at the controller 34 and/or sent to another device for storage, such as the test facility server 14.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A lidar trigger device, comprising:
a controller having a processor and memory, the memory storing computer instructions;
a wireless communications device;
a lidar unit having a light emitter and light detector;
an electronic display; and
a housing that surrounds the controller, the wireless communications device, the lidar unit, and the electronic display,
wherein, when the computer instructions are executed by the processor, the lidar trigger device is configured to:
cause light to be transmitted from the light emitter of the lidar unit;
cause reflected light that is received at the light detector to be processed;
determine whether the lidar unit was triggered based on processing of the reflected light;
in response to determining that the lidar unit was triggered, generate a trigger reporting message; and
send the trigger reporting message to a remote device via the wireless communications device.

2. The lidar trigger device of claim 1, wherein the lidar trigger device includes a printed circuit board (PCB) to which the controller, the wireless communications device, the lidar unit, and the electronic display are connected.

3. The lidar trigger device of claim 2, wherein the wireless communications device is or includes a cellular chipset.

4. The lidar trigger device of claim 1, wherein the lidar trigger device includes a global navigation satellite system (GNSS) receiver, and wherein the GNSS receiver is surrounded by the housing.

5. The lidar trigger device of claim 1, wherein the lidar unit is a single beam lidar device.

6. The lidar trigger device of claim 1, wherein the lidar trigger device is configured to determine whether the lidar unit was triggered based on distance data, and wherein the distance data is obtained based on the processing of the reflected light.

7. The lidar trigger device of claim 6, wherein the lidar trigger device is configured to determine that the lidar unit was triggered when the distance data indicates that an object is within a predetermined range of distances taken from the lidar trigger device.

8. The lidar trigger device of claim 1, wherein the trigger reporting message indicates a trigger time.

9. The lidar trigger device of claim 8, wherein the trigger reporting message indicates or includes distance data, and wherein the distance data is obtained based on the processing of the reflected light and indicates a distance at which an object was detected.

10. The lidar trigger device of claim 1, wherein the lidar trigger device is further configured so that sending the trigger reporting message includes publishing the trigger reporting message to a trigger data channel, and wherein the remote device is configured to access the trigger data channel so as to receive the trigger reporting message.

11. A method of reporting a trigger event at a test facility, wherein the method is carried out by a lidar trigger device having a controller that includes a processor and memory storing computer instructions; a wireless communications device; a lidar unit that includes a light emitter and light detector; an electronic display; and a housing that surrounds the controller, the wireless communications device, the lidar unit, and the electronic display, and wherein the method comprises the steps of:
causing light to be transmitted from the light emitter of the lidar unit;
causing reflected light that is received at the light detector to be processed;
determining whether the lidar unit was triggered based on processing of the reflected light;
in response to determining that the lidar unit was triggered, generating a trigger reporting message; and
sending the trigger reporting message to a remote device via the wireless communications device.

12. The method of claim 11, wherein the lidar trigger device includes a printed circuit board (PCB) to which the controller, the wireless communications device, the lidar unit, and the electronic display are connected.

13. The method of claim 12, wherein the wireless communications device is or includes a cellular chipset.

14. The method of claim 11, wherein the lidar trigger device includes a global navigation satellite system (GNSS) receiver, and wherein the GNSS receiver is surrounded by the housing.

15. The method of claim 11, wherein the lidar unit is a single beam lidar device.

16. The method of claim 11, wherein the lidar trigger device is configured to determine whether the lidar unit was triggered based on distance data, and wherein the distance data is obtained based on the processing of the reflected light.

17. The method of claim 16, wherein the lidar trigger device is configured to determine that the lidar unit was triggered when the distance data indicates that an object is within a predetermined range of distances taken from the lidar trigger device.

18. The method of claim 11, wherein the trigger reporting message indicates a trigger time.

19. The method of claim 18, wherein the trigger reporting message indicates or includes distance data, and wherein the distance data is obtained based on the processing of the reflected light and indicates a distance at which an object was detected.

20. The method of claim 11, wherein the step of sending the trigger reporting message includes publishing the trigger reporting message to a trigger data channel, and wherein the remote device is configured to access the trigger data channel so as to receive the trigger reporting message.
